(19) United States
(12) Patent Application Publication
(10) Pub. No.: US 2007/0227641 A1
(43) Pub. Date: Oct. 4, 2007

(54) Flowable compensation layer for multilayer devices

(76) Inventors: Daniel J. Skamser, Simpsonville, SC (US); Randal J. Vaughan, Fountain Inn, SC (US); March C. Maguire, Clemson, SC (US); Michael S. Randall, Simpsonville, SC (US); Gregory L. Crosby, Waterloo, SC (US)

Correspondence Address: NEXSEN PRUET, LLC, P.O. BOX 10648, GREENVILLE, SC, 29603, US

(21) Appl. No.: 11/397,131

(22) Filed: Apr. 4, 2006

(51) Int. Cl. C03B 29/00; H01G 4/06

(52) U.S. Cl. 156/89.12; 156/89.16; 361/321.3; 156/277

(57) ABSTRACT

A process for forming a multilayer ceramic capacitor. The process includes forming a ceramic precursor layer and depositing an electrode precursor in a predetermined pattern on the ceramic precursor layer to form a first patterned sheet. A flowable ceramic precursor is applied to the first patterned sheet. At least one second patterned sheet is applied to the first patterned sheet to form a layered patterned sheet and the layered patterned sheet is laminated.

### BACKGROUND OF THE INVENTION

The present invention is related to an improved method for forming a multilayer device and a device formed thereby. More particularly, the present invention is related to the formation of a multilayer device wherein flowable materials are incorporated into the margins of a patterned coated layer. During lamination the patterned margins are partially filled by a flowable ceramic to minimize changes in dielectric and electrode layer thickness.

Manufacturing of multilayer devices by lamination is a standard practice particularly in the manufacture of multi-layer ceramic capacitors (MLCC). As with any electronic component the ongoing desire for miniaturization places continued burdens on every aspect of product properties and product manufacture thereby forcing those of skill in the art to continue to advance the art. It is highly desirable to increase the layer count while concurrently decreasing the layer thickness.

As layer counts in a multilayer device increase and as the dielectric and electrode thicknesses decrease the manufacturing difficulties increase. In particular, it becomes increasingly more difficult to manufacture a device with minimal layer distortion. Layer distortion is detrimental to the physical properties of the capacitor and is now realized to represent a significant cause of inferiority in capacitors. Past efforts to minimize physical distortion have involved optimization of the lamination time, temperature and pressure.

One method for minimizing distortion is to print a ceramic material between the electrodes with a thickness approximately equal to the electrode thickness. This technique is beneficial yet it is difficult to achieve. There has been a considerable amount of effort directed to printing the dielectric with sufficient location and volume control to fill the margin area without underfilling or overfilling and without overlapping the electrode. As the thickness decreases and the number of layers increases this problem is even more pronounced thereby insuring that any current solution to the inherent printing errors will be insufficient in the near future. Furthermore, the ceramic is substantially rigid during lamination and any error in layer thickness or location is irreversible.

Examples of prior art attempts to solve the problems of printing accuracy include U.S. Pat. Nos. 6,475,317 and 6,692,598. These techniques are highly susceptible to errors in printing location or printing volume even though it is this deficiency which they both attempt to overcome.

There has been an ongoing desire in the art for a method of forming multilayer ceramic products with minimal distortion of the internal layers. The present invention achieves these goals.

### SUMMARY OF THE INVENTION

It is an object of the invention to provide a method for manufacturing multilayer ceramic components with minimal distortion of the individual layers.

It is another object of the invention to provide a method for manufacturing multilayer ceramic components with minimal reliance on printing precision.

It is yet another object of the invention to provide a method for manufacturing multilayer ceramic components which greatly increases manufacturing productivity by minimizing the precision required at printing and mitigating the product deficiencies created by inherent printing errors with respect to both location and volume.

A particular advantage of the present invention is the ability to realize the aforementioned objects without significant modification of equipment and processes thereby greatly enhancing the manufacturing capability with existing equipment.

These and other advantages, as will be realized, are provided in a process for forming a multilayer ceramic capacitor. The process includes depositing a ceramic precursor on a substrate. An electrode ink is deposited on the ceramic precursor in a predetermined pattern to form a patterned sheet. A flowable ceramic precursor is applied to the patterned sheet.

Yet another embodiment is provided in a process for forming a multilayer ceramic capacitor. The process includes depositing a ceramic precursor on a substrate. An electrode precursor is deposited on the ceramic precursor in a first predetermined pattern. A flowable ceramic precursor is deposited in a second predetermined pattern to form a patterned sheet with flowable ceramic and electrodes. The patterned sheet is overlayed with at least one second patterned sheet to form a layered patterned sheet. The layered patterned sheet is laminated under pressure wherein the flowable ceramic flows to partially fill an area between the electrodes.

Yet another embodiment is provided in a process for forming a multilayer ceramic capacitor. The process includes forming a ceramic precursor layer and depositing an electrode precursor in a predetermined pattern on the ceramic precursor layer to form a first patterned sheet. A flowable ceramic precursor is applied to the first patterned sheet. At least one second patterned sheet is applied to the first patterned sheet to form a layered patterned sheet and the layered patterned sheet is laminated.

Yet another embodiment is provided in a process for forming a multilayer ceramic capacitor. The process includes depositing a ceramic precursor. An electrode precursor is deposited in a first predetermined pattern on the ceramic precursor. A flowable ceramic precursor is deposited in a second predetermined pattern to form a first patterned sheet with flowable ceramic and electrodes. The first patterned sheet is overlayed with a second patterned sheet to form a layered patterned sheet and the layered patterned sheet is laminated wherein the flowable ceramic flows to partially fill an area between the electrodes.

### BRIEF DESCRIPTION OF FIGURES

FIG. 1 illustrates a capacitor in partial cut-away view.

FIG. 2 illustrates a preferred process of the present invention.

FIG. 3 illustrates an embodiment of the present invention wherein the margin area is partially filled.

FIG. 4 illustrates the embodiment of FIG. 3 after lamination.

FIG. 5 illustrates an embodiment of the present invention wherein the flowable ceramic is coated over the electrodes.

FIG. 6 illustrates the embodiment of FIG. 5 after lamination.

### DETAILED DESCRIPTION

The instant invention will be described with reference to the various drawings forming an integral part of the specification. In the various drawings similar elements will be numbered accordingly.

An improved method for manufacturing a multilayer ceramic device is provided herein. The method includes applying a flowable ceramic material wherein the material is flowable during lamination.

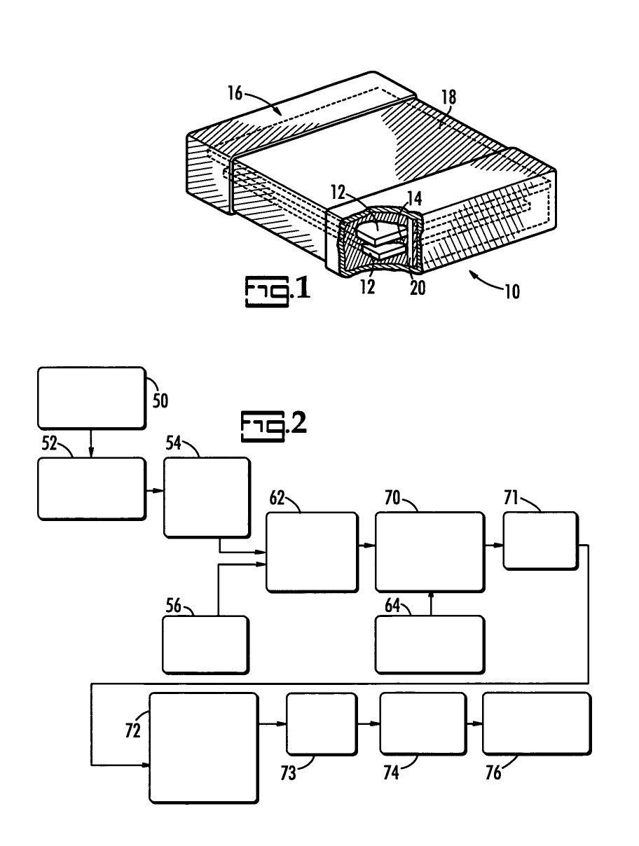

A multilayer ceramic device is illustrated in FIG. 1. In FIG. 1, the device, generally represented at 10, comprises internal electrodes, 12, with dielectric, 14, there between. As would be realized the plates are alternately in contact with external electrodes, 16, of opposite polarity. External electrodes are also referred to as terminations. A ceramic dielectric, 18, acts as a protective barrier. An internal layer, 20, facilitates electrical connectivity between the internal electrode and the external electrodes. Two plates are illustrated for clarity but it is understood that the number of alternate plates can be hundreds or thousands.

The internal electrodes are a layer of conductive metal and are not particularly limited herein. The ceramic material is not particularly limiting herein, however, ceramics prepared by low-temperature sintering precursors or precursors which can be sintered in a non-oxidizing atmosphere are preferred. The internal electrode layer is preferably a nickel layer and the external electrode is preferably a combination of copper, nickel and tin to facilitate soldering.

The process for manufacturing a multilayer ceramic capacitor will be described with reference to FIG. 2.

In FIG. 2, a ceramic powder is prepared at 50. The ceramic powder comprises ceramic precursors, organic vehicles, coating aids, and other ingredients typically utilized in ceramic capacitor formation. The ceramic powder is thoroughly mixed as known in the art to form a ceramic coating material at 52. The ceramic coating material is formed into a layer by application to a substrate or by formation of a self supporting film thereby forming a ceramic dielectric tape at 54. In a parallel process the metal powders are prepared at 56. The metal powders are not particularly limited herein. The metal powders are incorporated into a matrix to form an electrode precursor which is then deposited on the ceramic dielectric tape at 62 in a predetermined pattern thereby forming a patterned sheet. The flowable ceramic precursor is prepared at 64. It is most preferred that the flowable ceramic precursor have the same ceramic precursors, or ceramic components, as that in the capacitive element to insure that the thermal expansion parameters are compatible. The flowable ceramic precursor is applied at 70. The flowable ceramic precursor is either applied in the margin between the electrode deposits or as a layer over lapping the electrode precursor deposits.

At least one patterned sheet is stacked at 72, to the underlying patterned sheet and laminated thereto. This process is repeated until the predetermined number of layers is obtained. It is preferable that each subsequent printed tape be laminated prior to layering of any additional printed tape. A particular advantage of the present invention is that the flowable ceramic material can be applied in an amount less than that required to fill the margin area. As the lamination pressure and/or temperature increases the ceramic flows without significantly distorting the layers on either side thereof.

After the required number of layered sheets are in place the layered structure is subjected to singulation at 73 and then subjected to a thermal process at 74 wherein the ceramic precursors are sintered and volatiles are removed as well known in the art to form a fired capacitor precursor. The fired capacitor precursor is finished at 76 wherein the corners are preferably rounded and the terminations are applied to form the finished capacitor.

An embodiment of the present invention will be described with reference to FIG. 3. In FIG. 3, a dielectric, 30, has electrodes, 31, coated thereon in a predetermined pattern. In the margin area between the electrodes a flowable ceramic precursor, 32, is applied in an amount which is insufficient to fully fill the volume of the margin area after compression but with a thickness which is preferably more than the electrodes when measured perpendicular to the dielectric. As would be realized the flowable ceramic does not completely fill the voids of the margin and may protrude above the plane defined by the upper surface of the electrodes. As a subsequent printed sheet is placed on the illustrated printed sheet the flowable ceramic deforms during lamination while supporting the upper layer yet with sufficient flexibility too flow into areas of the margin during lamination thereby eliminating distortion of additional layers.

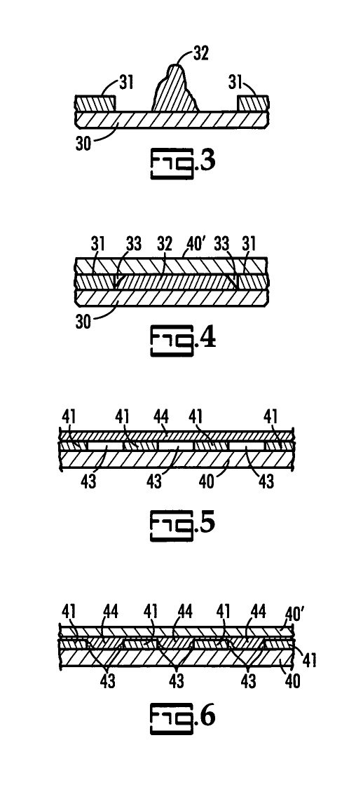

FIG. 4 illustrates the embodiment of FIG. 3 after lamination. In FIG. 4, a dielectric layer, 40′, causes the flowable ceramic, 32, to at least partially fill the void between the electrodes, 31. Voids, 33, may remain or the fill may densify thereby leaving a small volume original void which is not filled.

Yet another embodiment is illustrated in FIG. 5. In FIG. 5 the dielectric, indicated at 40, has electrodes, 41, coated thereon in a predetermined pattern. Between electrodes are margin areas, 43. A layer of flowable ceramic precursor is applied over the electrodes whereby the margin areas are vacant and covered.

A second sheet is laid over the flowable. As well known to those of skill in the art each layer is overlayed in registered fashion such that the electrodes form alternating layers extending beyond the projection on opposing sides for later formation of external termination. The layered structure is then laminated preferably under pressure and/or temperature. During lamination the flowable ceramic flows into the margin area as illustrated in FIG. 6. The capacitor is sequentially manufactured by incorporation of additional layers preferably with lamination there between until the predetermined number of layers is achieved. The resistance to compression provided by the flowable ceramic minimizes distortion of the additional layers while at the same time the flowing ceramic fills the void evenly but not necessarily completely. After lamination the flowable ceramic forms an integral part of the ceramic layer, 40′, with the thickness is controlled by lamination pressure and/or temperature. As would be realized the layer thickness of the ceramic layer, 40, would be adjusted to compensate for the additional ceramic thickness provided by the flowable ceramic.

The ceramic layer may be coated on a support as a paste, or ink, or it may be formed into a self-supporting sheet. The precursor for forming the dielectric layers can be obtained by mixing a raw dielectric material with an organic vehicle. The raw dielectric material may be a mixture of oxides and composite oxides as previously mentioned. Also useful are various compounds which convert to such oxides and composite oxides upon firing. These include, for example, carbonates, oxalates, nitrates, hydroxides, and organometallic compounds. The dielectric material is obtained by selecting appropriate species from these oxides and compounds and mixing them. The proportion of such compounds in the raw dielectric material is determined such that after firing, the specific dielectric layer composition may be met. The raw dielectric material is generally used in powder form having a mean particle size of about 0.1 to about 3 μm, preferably about 0.2 to 0.7 μm.

The organic vehicle, or organic additive, is a binder in an organic solvent. The binder used herein is not critical and may be suitably selected from conventional binders such as ethyl cellulose. Also the organic solvent used herein is not critical and may be suitably selected from conventional organic solvents such as terpineol, butylcarbinol, acetone, and toluene in accordance with a particular application method such as a printing or sheeting method.

The flowable ceramic precursor is a printable material which is a flowable ceramic after solvent removal. The flowable ceramic does not flow at ambient conditions but does flow under lamination conditions without fracture. A particular advantage is realized in that the flowable ceramic supports the additional layers yet is flexible enough to flow into the voids during lamination. The net effect is a cushioning during lamination which greatly improves the overall lamination process and layer quality. The flowable ceramic precursor comprises a dielectric, a binder, and a solvent.

The dielectric for the flowable ceramic precursor preferably flows prior to the dielectric layer and is preferably more malleable than the dielectric layer. The flowable ceramic precursor is preferably selected from titanates such as barium titanate, strontium titanate, calcium titanate, magnesium titanate, zinc titanate, lanthanum titanate, neodymium titanate and lead titanate; zirconates such as barium zirconate calcium zirconate and lead zirconate; stannates, such as barium stannate and calcium stannate and combinations thereof. The ceramic is preferably spherical or rounded but can have irregular shapes. The particle size, as defined by D₅₀, is preferably in the range of 5% to 33% of the thickness of the fired dielectric layer or 1 nm to 1 μm. More preferably the particle size, D₅₀, is between 0.15 μm to 1.00 μm. The size distribution is defined such that the D₁₀ to D₉₀ is less than one order of magnitude or from about 50 mn to 500 nm. For the purposes of the present application D50 is the median diameter using light scattering techniques to measure the particle size. It is most preferred that the particles have a surface roughness (R_{z}) of less than 150 nm and more preferably less than 75 nm as measured by transmissive electron microscopy or atomic force measurements. Dopants may be included in the flowable ceramic such as lanthanides, magnesium, calcium or manganese.

The binder for the flowable ceramic precursor is any suitable hydrocarbon capable of forming a matrix which can be volatilized. Particularly preferred binder materials include ethyl cellulose, polyvinyl butyral, acrylics and mixtures thereof. The binder and dielectric, or solids component of the precursor, preferably comprise about 60 to 90%, by volume, dielectric and 10 to 40%, by volume, binder. More preferably the solids component comprises about 50 to 70%, by volume, dielectric and 10 to 40%, by volume, binder and about 60%, by volume, dielectric is preferred.

The solvent for the flowable ceramic precursor is chosen for compatibility, the drying rate and manufacturing or environmental concerns. Particularly preferred solvents include toluene, terpineol and alcohols.

The flowable ceramic precursor may further comprise additional adjuvants including dispersants; surfactants; rheology modifiers; adhesion adjusters such as tackifiers, Santicizer S-160 and Abitol; HC resins such as Escorez; rosins and acrylics; shrinkage adjusters such as sintering aids, glasses, oxides or refractory additives; flow enhancers such as phthalates, particularly butyl benzyl phthalates, dioctyl phthalates and dibutyl phthalates; and adipates.

The electrode precursor for forming the internal electrode layers can be in the form of a paste, or ink, and is obtained by mixing an electro-conductive material with an organic vehicle. The conductive material used herein includes conductors such as conductive metals and alloys as mentioned above and various compounds which convert into such conductors upon firing, for example, oxides, organometallic compounds and resinates. The organic vehicle is as mentioned above.

Paste for forming external electrodes is prepared by the same method as the internal electrodes layer-forming paste.

No particular limit is imposed on the organic vehicle content of the respective pastes mentioned above. Often the paste contains about 1 to 5 wt % of the binder and about 10 to 50 wt % of the organic solvent. If desired, the respective pastes may contain any other additives such as dispersants, plasticizers, dielectric compounds, and insulating compounds. The total content of these additives is preferably up to about 10 wt %.

The dielectric layers may have an appropriate Curie temperature which is determined in accordance with the applicable standards by suitably selecting a particular composition of dielectric material. Typically the Curie temperature is higher than 45° C., especially about 65° C. to 125° C.

Each dielectric layer preferably has a thickness of up to about 10 μm, more preferably up to about 2 μm. The lower limit of thickness is about 0.3 to 0.5 μm, preferably about 0.5 μm. The number of dielectric layers stacked is generally from 100 to over 1,500, preferably from 200 to about 1200.

A particularly preferred ceramic comprises barium titanate, barium strontium titanate or barium strontium zirconium titanate at up to about 90 wt % with any of the lanthanides (Y, Er, Yb, Dy, Ho) as dopants at up to about 3 wt %; either Mg, Ca, or Mn or a combination thereof at no more than about 2 wt % and fluxing agent, such as a silicate glass at no more than about 6 wt %.

A patterned sheet may be prepared from the dielectric layer-forming paste and the internal electrode layer-forming paste. In the case of a printing method, a patterned sheet is prepared by alternately printing the pastes onto a substrate of polyethylene terephthalate (PET), for example, in laminar form, cutting the laminar stack to a predetermined shape and separating it from the substrate.

Also useful is a sheeting method wherein a layered sheet is prepared by forming sheets from the dielectric layer-forming paste, printing the internal electrode layer-forming paste on the respective sheets, and stacking the printed sheets.

The stacked printed sheets are preferably laminated then singulated into individual units by a saw or blade after which the binder is removed from the chip and fired. Binder removal may be carried out under conventional conditions, preferably under the following conditions where the internal electrode layers are formed of a base metal conductor such as nickel and nickel alloys.

The heating rate is preferably about 5 to 300° C./hour, more preferably 10 to 100° C./hour. The holding temperature is preferably about 200 to 400° C., more preferably 250 to 300° C. The holding time is preferably about ½ to 24 hours, more preferably 5 to 20 hours. The atmosphere is preferably non-oxidizing such as a wet atmosphere with less than 3% oxygen. The green chip is then fired in an atmosphere with an oxygen partial pressure of 10⁻⁸ to 10⁻¹² atm. Extremely low oxygen partial pressure should be avoided, since at such low pressures the conductor can be abnormally sintered and may become disconnected from the dielectric layers. At oxygen partial pressures above the range, the internal electrode layers are likely to be oxidized.

For firing, the chip preferably is held at a temperature of 1,100° C. to 1,400° C., more preferably 1,150 to 1,300° C. Lower holding temperatures below the range would provide insufficient densification whereas higher holding temperatures above the range can lead to poor DC bias performance. Remaining conditions for sintering preferably are as follows. Heating rate: 50 to 500° C./hour, more preferably 200 to 300° C./hour. The holding time is preferably about ½ to 8 hours, more preferably 1 to 3 hours. The cooling rate is preferably about 50 to 500° C./hour, more preferably 200 to 300° C./hour. The firing atmosphere preferably is a reducing atmosphere. An exemplary atmospheric gas is a humidified mixture of N₂ and H₂ gases.

Firing of the capacitor chip in a reducing atmosphere preferably is followed by annealing. Annealing is effective for re-oxidizing the dielectric layers, thereby optimizing the resistance of the ceramic to dielectric breakdown. The annealing atmosphere may have an oxygen partial pressure of at least 10⁻⁶ atm., preferably 10⁻⁵ to 10⁻⁴ atm. The dielectric layers are not sufficiently re-oxidized at a low oxygen partial pressures below the range, whereas the internal electrode layers are likely to be oxidized at oxygen partial pressures above this range.

For annealing, the chip preferably is held at a temperature of lower than 1,100° C., more preferably 500° C. to 1,000° C. Lower holding temperatures below the range would oxidize the dielectric layers to a lesser extent, thereby leading to a shorter life. Higher holding temperatures above the range can cause the internal electrode layers to be oxidized (leading to a reduced capacitance) and to react with the dielectric material (leading to a shorter life). Annealing can be accomplished simply by heating and cooling. In this case, the holding temperature is equal to the highest temperature on heating and the holding time is zero.

Remaining conditions for annealing preferably are as follows. The holding time is preferably about 0 to 20 hours, more preferably 6 to 10 hours. The cooling rate is preferably about 50 to 500° C./hour, more preferably 100 to 300° C./hour.

The preferred atmospheric gas for annealing is humid nitrogen gas. The nitrogen gas or a gas mixture used in binder removal, firing, and annealing, may be humidified using a wetter. In this regard, water temperature preferably is about 5 to 75° C.

The binder removal, firing, and annealing may be carried out either continuously or separately. If done continuously, the process includes the steps of binder removal, changing only the atmosphere without cooling, raising the temperature to the firing temperature, holding the chip at that temperature for firing, lowering the temperature to the annealing temperature, changing the atmosphere at that temperature, and annealing.

If done separately, after binder removal and cooling down, the temperature of the chip is raised to the binder-removing temperature or higher in dry or humid nitrogen gas to remove residual carbon. The atmosphere then is changed to a reducing one, and the temperature is further raised for firing. Thereafter, the temperature is lowered to the annealing temperature and the atmosphere is again changed to dry or humid nitrogen gas, and cooling is continued. Alternately, once cooled down, the temperature may be raised to the annealing temperature in a nitrogen gas atmosphere. The entire annealing step may be done in a humid nitrogen gas atmosphere.

The resulting chip may be polished at end faces by barrel tumbling and sand blasting, for example, before the external electrode-forming paste is printed or transferred and baked to form external electrodes. Firing of the external electrode-forming paste may be carried out under the following conditions: a humid mixture of nitrogen and hydrogen gases, about 600 to 800° C., and about 10 minutes to about 1 hour.

Finished electrodes are preferably formed on the external electrodes by plating or other methods known in the art.

The multilayer ceramic chip capacitors of the invention can be mounted on printed circuit boards, for example, by soldering.

The method of applying the ceramic precursor and electrode material is not particularly limiting herein. Particularly preferred methods include transfer methods and direct methods. In transfer methods the ceramic or electrode precursors are applied to a substrate and then transferred to the tape. In direct methods the ceramic or electrode precursors are applied as an ink by a coating or printing technique such as ink jet, screen printing, xerography, patch coating, pad coating, flexography and gravure. The electrode is preferably applied by either a screen printing technique or an ink jet technique. The dielectric material is preferably applied by a transfer technique. If dielectric is applied to the margins between the electrodes it is preferable that the dielectric be applied by a direct technique.

The present invention has been described with particular reference to the preferred embodiments without limit. It would be apparent to one of skill in the art, based on the description herein, that alternate embodiments could be envisioned without departing from the scope of the invention which is specifically set forth in the claims appended hereto.

Claimed is:

1. A process for forming a multilayer ceramic device comprising:
forming a ceramic precursor layer;
depositing an electrode precursor in a predetermined pattern on said ceramic precursor layer to form a first patterned sheet;
applying a flowable ceramic precursor to said first patterned sheet;
stacking at least one second patterned sheet to said first patterned sheet to form a layered patterned sheet; and
laminating said layered patterned sheet.

2. The process for forming a multilayer ceramic capacitor of claim 1 comprising forming said ceramic precursor layer on a substrate.

3. The process for forming a multilayer ceramic capacitor of claim 1 wherein said flowable ceramic precursor is applied in an area between said predetermined pattern of said electrode ink.

4. The process for forming a multilayer ceramic capacitor of claim 1 wherein said flowable ceramic precursor is applied in a sheet on said predetermined pattern of said electrode ink.

5. The process for forming a multilayer ceramic capacitor of claim 1 wherein said flowable ceramic precursor flows during said laminating.

6. The process for forming a multilayer ceramic capacitor of claim 1 wherein said electrode precursor is deposited by a method selected from ink jet, screen printing, xerography, patch coating, pad coating, flexography and gravure.

7. The process for forming a multilayer ceramic capacitor of claim 6 wherein said electrode precursor is deposited by an ink jet method.

8. The process for forming a multilayer ceramic capacitor of claim 6 wherein said electrode precursor is deposited by screen printing.

9. The process for forming a multilayer ceramic capacitor of claim 1 wherein said flowable ceramic precursor is deposited by a method selected from ink jet, screen printing, xerography, patch coating, pad coating, flexography and gravure.

10. The process for forming a multilayer ceramic capacitor of claim 9 wherein said flowable ceramic precursor is deposited by an ink jet method.

11. The process for forming a multilayer ceramic capacitor of claim 9 wherein said flowable ceramic precursor is deposited by screen printing.

12. The process for forming a multilayer ceramic capacitor of claim 1 wherein a solids component of said flowable ceramic precursor comprises 60-90%, by volume, dielectric and 10-40%, by volume, organic additive.

13. The process for forming a multilayer ceramic capacitor of claim 12 wherein said solids component comprises 50-70%, by volume, dielectric.

14. The process for forming a multilayer ceramic capacitor of claim 1 wherein said flowable ceramics precursor comprises a dielectric with a D₅₀ which is 5-33% of the thickness of a fired dielectric layer.

15. The process for forming a multilayer ceramic capacitor of claim 1 wherein said flowable ceramics precursor comprises a dielectric with a D₅₀ of 1 nm to 1 μm.

16. The process for forming a multilayer ceramic capacitor of claim 15 wherein said dielectric has a D₅₀ of 0.15 μm to 0.5 μm.

17. A capacitor formed by the method of claim 1.

18. A process for forming a multilayer ceramic capacitor comprising:
depositing a ceramic precursor;
depositing an electrode precursor in a first predetermined pattern on said ceramic precursor;
depositing a flowable ceramic precursor in a second predetermined pattern to form a first patterned sheet with flowable ceramic and electrodes;
overlaying said first patterned sheet with a second patterned sheet to form a layered patterned sheet; and
laminating said layered patterned sheet under pressure wherein said flowable ceramic flows to partially fill an area between said electrodes.

19. The process for forming a multilayer ceramic capacitor of claim 18 comprising depositing said ceramic precursor on a substrate.

20. The process for forming a multilayer ceramic capacitor of claim 18 wherein said second predetermined pattern is deposited in areas not covered by said first predetermined pattern.

21. The process for forming a multilayer ceramic capacitor of claim 18 wherein said second predetermined pattern at least partially overlaps said first predetermined pattern.

22. The process for forming a multilayer ceramic capacitor of claim 18 wherein a solids component of said flowable ceramic precursor comprises 60-90%, by volume, dielectric and 10-40%, by volume, organic additive.

23. The process for forming a multilayer ceramic capacitor of claim 22 wherein said solids component comprises 50-70%, by volume, dielectric.

24. The process for forming a multilayer ceramic capacitor of claim 18 wherein said flowable ceramics precursor comprises a dielectric with a D₅₀ which is 5-33% of the thickness of a fired dielectric layer.

25. The process for forming a multilayer ceramic capacitor of claim 18 wherein said flowable ceramics precursor comprises a dielectric with a D₅₀ of 1 nm to 1 μm.

26. The process for forming a multilayer ceramic capacitor of claim 25 wherein said dielectric has a D₅₀ of 0.15 μm to 0.5 μm.

27. The process for forming a multilayer ceramic capacitor of claim 18 wherein at least one of said electrode precursor or said flowable ceramic precursor is deposited by a method selected from ink jet, screen printing, xerography, patch coating, pad coating, flexography and gravure.

28. The process for forming a multilayer ceramic capacitor of claim 27 wherein at least one of said electrode precursor or said flowable ceramic precursor is deposited by an ink jet method.

29. The process for forming a multilayer ceramic capacitor of claim 28 wherein at least one of said electrode precursor or said flowable ceramic precursor is deposited by screen printing.

30. A capacitor formed by the process of claim 18.
